(19) United States
(12) Patent Application Publication
(10) Pub. No.: US 2008/0210792 A1
(43) Pub. Date: Sep. 4, 2008

(54) SALT AND PEPPER MILLS ADAPTED TO RESEMBLE SLOT MACHINES

(76) Inventors: Ron Meiry, Las Vegas, NV (US); Ronen Tregerman, Las Vegas, NV (US)

Correspondence Address: LAW OFFICES OF ERIC KARICH, 2807 ST. MARK DR., MANSFIELD, TX, 76063, US

(21) Appl. No.: 11/969,093

(22) Filed: Jan. 3, 2008

Related U.S. Application Data
(63) Continuation-in-part of application No. 11/649,978, filed on Jan. 5, 2007.

(51) Int. Cl. A47J 42/00; A01D 34/90; A47J 43/00

(52) U.S. Cl. 241/169.1

(57) ABSTRACT

A mill adapted to resemble a slot machine has a mill body, a dispensing mechanism, and a façade that resembles a slot machine. The mill body has a compartment for storing the pepper, and an aperture for dispensing the pepper. The dispensing mechanism is operably mounted adjacent the aperture for grinding and dispensing the pepper through the aperture. The facade of the mill body is adapted to resemble a slot machine, and a slot arm is pivotally mounted adjacent the mill body and operably engaged for actuating the dispensing mechanism.

### CROSS-REFERENCE TO RELATED APPLICATIONS

This application for a utility patent is a continuation-in-part of a previously filed utility patent, still pending, having application Ser. No. 11/649,978, filed Jan. 5, 2007.

### STATEMENT REGARDING FEDERALLY SPONSORED RESEARCH

Not Applicable

### BACKGROUND OF THE INVENTION

1. Field of the Invention

This invention relates generally to salt and pepper mills, and more particularly to salt and pepper mills adapted to resemble slot machines.

2. Description of Related Art

Slot machines, poker machines, fruit machines, or similar or related gaming machines, are types of casino games that are coin-operated machines with three or more reels, which spin when a lever on the side of the machine is pulled. The slot machine is also known informally as a one-armed bandit because of its traditional appearance and its ability to leave the gamer penniless.

The machines include a currency detector that validates the money inserted to play. The machine typically pays off based on symbols visible on the reels when they stop. Modern computer technology has resulted in many variations on the slot machine concept. Today, slot machines are the most popular gambling method in casinos and constitute well over 50% of the average casino's income.

Many gamblers would like to take home a memento of a trip to a gambling location, such as Las Vegas, and a device that includes a slot machine would make an excellent memento or gift.

The prior art teaches various forms and types of slot machines. However, the prior art does not teach a slot machine integrated with a useful domestic item like a salt or pepper mill. The present invention fulfills these needs and provides further related advantages as described in the following summary.

### SUMMARY OF THE INVENTION

The present invention teaches certain benefits in construction and use which give rise to the objectives described below.

The present invention provides a mill for dispensing a spice. The mill is adapted to resemble a slot machine, and includes a mill body, a dispensing mechanism, and a façade that resembles a slot machine. The mill body has a compartment for storing the spice, and an aperture for dispensing the spice. The dispensing mechanism is operably mounted adjacent the aperture for dispensing the spice through the aperture. The facade of the mill body is adapted to resemble a slot machine, and a slot arm is pivotally mounted adjacent the mill body and operably engaged for actuating the dispensing mechanism. A primary objective of the present invention is to provide a mill having advantages not taught by the prior art.

Another objective is to provide a mill that includes a façade that is adapted to resemble a slot machine.

Another objective is to provide a mill that includes a slot arm for actuating a dispensing mechanism for dispensing a spice.

A further objective is to provide a mill that includes reels and a reel actuator so that the mill closely resembles a slot machine, and may even function as a slot machine.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1 is a perspective view of a mill according to a preferred embodiment of the present invention;

FIG. 2 is a front elevational view thereof;

FIG. 3 is a rear elevational view thereof, with a portion of the mill broken away to illustrate a dispensing mechanism of the mill; and

FIG. 4 is a block diagram of the mill.

### DETAILED DESCRIPTION OF THE INVENTION

The above-described drawing figures illustrate the invention, a mill 10 adapted to resemble a slot machine.

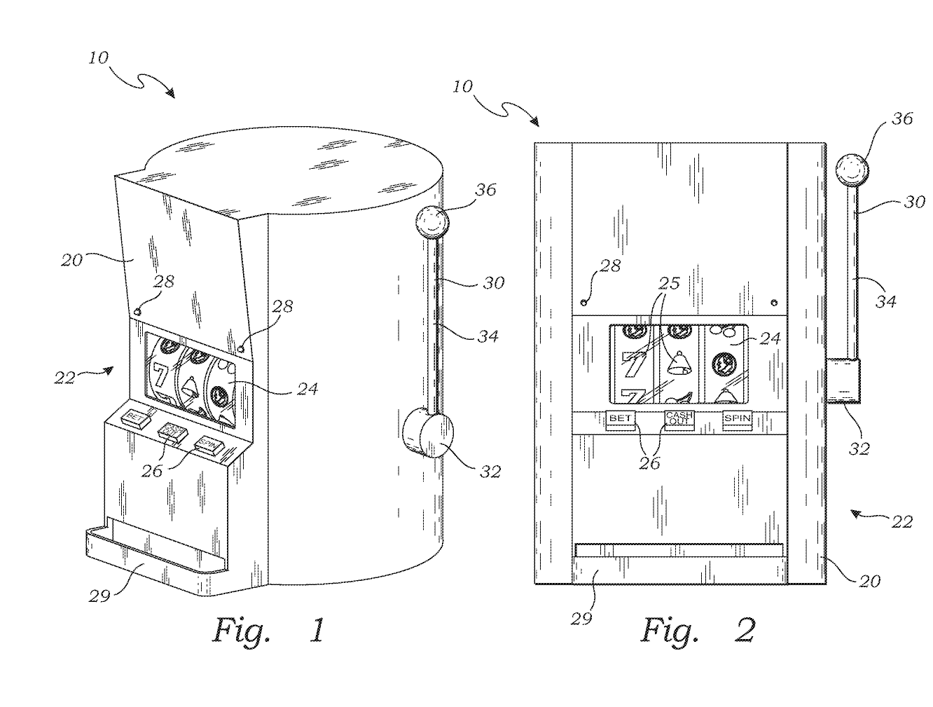

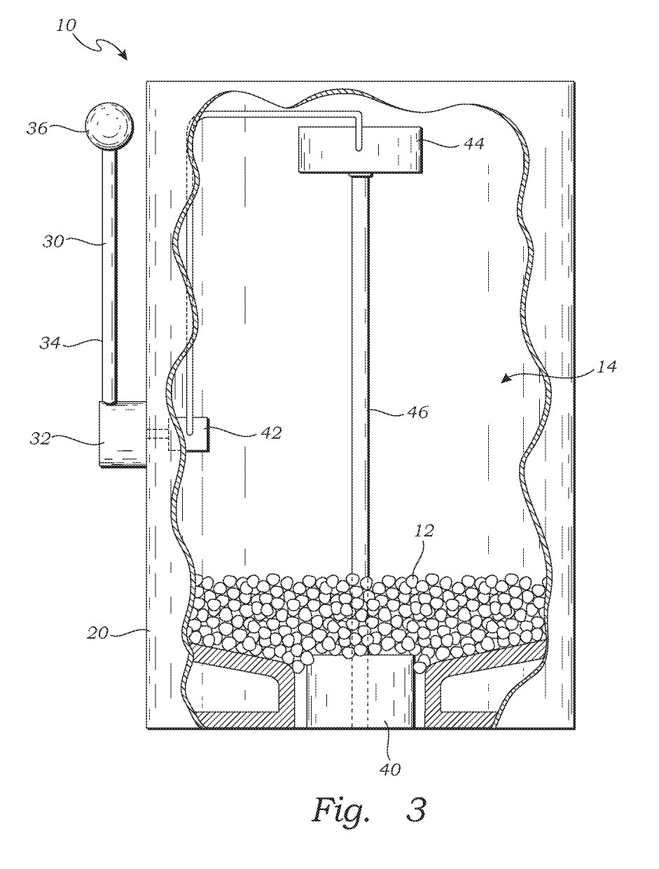

FIG. 1 is a perspective view of the mill 10 according to a preferred embodiment of the present invention, and FIG. 2 is a front elevational view thereof. As illustrated in FIGS. 1 and 2, the mill 10 includes a mill body 20 having a façade 22 adapted to resemble a slot machine. The façade 22 may include reels 24, buttons 26, LEDs 28, a coin mill 29 (functional or not), and any other features that add to the resemblance of a slot machine. A slot arm 30 is operably connected to the mill body 20 with a pivot element 32 such that a rod 34 extends vertically (defined to include approximately or generally vertical) from the pivot element 32. The rod 34 may include a ball 36 at the top. The slot arm 30 functions to actuate the dispensing of pepper, as discussed in greater detail below. The slot arm 30 may also actuate the reels 24 as with a standard slot machine, and also illuminate the LEDs 28, and any other features desired.

The façade 22, in cooperation with the slot arm 30, is adapted to make the mill 10 resemble a slot machine. The reels 24 preferably each including a plurality of slot symbols 25 printed or otherwise formed on the reel 24. The slot symbols 25 may include traditional symbols, such as fruit, bars, the number “7,” and similar symbols. For purposes of this application, the term “printed” is defined to include adhering stickers, etching, any form of printing, molding, or any other or equivalent means of marking or forming the symbols 25 on the reels 24. The reels 24 may be functional, as discussed in greater detail below, or they may be non-functional and purely a false façade.

The façade 22 may also include shapes and symbols common to the gaming industry, printed or otherwise formed on the mill body 20. Those skilled in the art may devise many alternative constructions and arrangements of symbols and elements that make the mill body 20 resemble the body of a slot machine, and such alternatives should be considered within the scope of the present invention.

For purposes of this application, the term slot machine is hereby defined to include any form of slot machine, poker machine, “fruit machine,” or related form of casino game consistent with the spirit of the present invention.

FIG. 3 is a rear elevational view thereof with a portion of the mill 10 broken away to show a dispensing mechanism 40, in this case a pepper grinding mechanism, within the mill 10. The mill 10 is preferably adapted to grind and dispense pepper 12. However, as used in this application, the term pepper is hereby defined to include any material, such as salt, or any other form of spice or similar material.

The dispensing mechanism 40 is any mechanism that functions to dispense the pepper 12 (or salt of other form of spice or related material). In the preferred embodiment, wherein the pepper mill 10 dispenses pepper 12, the dispensing mechanism 40 may be a pepper grinding mechanism that simultaneously grinds and dispenses pepper corn. In alternative embodiments, it may simply dispense previously ground pepper. If the mill 10 dispenses salt or another spice, the dispensing mechanism 40 may simply dispense the spice without actually grinding the spice.

The slot arm 30 functions to activate and/or actuate the dispensing mechanism 40. In one embodiment, the slot arm 30 actuates a controller 42 that actuates a motor 44 that turns a shaft 46 that turns the dispensing mechanism 40. This embodiment is discussed in greater detail below. In an alternative embodiment (not illustrated), the slot arm 30 directly and manually actuates the grinding mechanism 40, through gears or similar mechanism, such as may be devised by one skilled in the art. Since the general construction of pepper mills (or pepper grinders) are well known in the art, this aspect of the invention is not discussed in greater detail herein, and various alternative embodiments of the pepper mill mechanisms should be considered within the scope of the present invention.

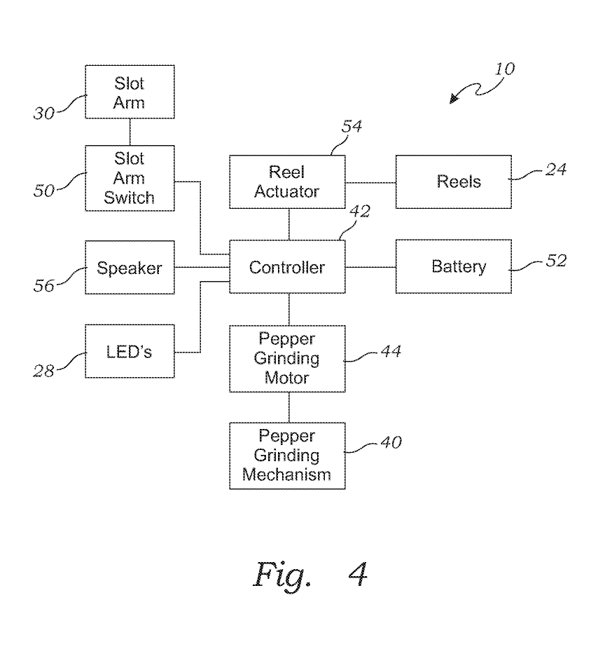

FIG. 4 is a block diagram of the pepper mill 10. As illustrated in FIG. 4, the pepper mill 10 preferably includes the controller 42 operably connected to a slot arm switch 50 of the slot arm 30, and to a battery 52 (defined to include any equivalent power source). The controller 42 is also preferably operably connected to a reel actuator 54 and the motor 44, such that pulling the slot arm 30 actuates the reel actuator 54 for spinning the reels 24, and operably controlling the motor for actuating the dispensing mechanism 40.

In the preferred embodiment, the controller 42 is also operably connected to the LEDs 28 mounted on the mill body 20, forming part of the facade 22. When the slot arm 30 is pulled, the controller 42 initiates illumination of the LED's 28, steadily illuminated or flashing, to add to the facade 22 of the mill body 20. In some embodiments, the controller 42 is operably connected to speakers 56 for playing sound effects, beeps, the sound of money being dispensed from a slot machine, or any other sound effects to add to the amusement of the pepper mill 10. For purposes of this application, the term LED is hereby meant to include any form of lighting, including but not limited to incandescent lighting, fluorescent bulbs, electro luminescent strips, LED's, and any other form of lighting whereas illumination consistent with the present application. The term speaker is hereby defined to include any form of speaker, buzzer, noise maker, or any other form of device for giving a verbal message, sound effects, or sounds consistent with the present invention.

The terminology used above is defined to include the words described above, as well as similar or equivalent words, or derivatives thereof. Additionally, the words “a,” “an,” and “one” are defined to include one or more of the referenced item unless specifically stated otherwise. Also, the terms “have,” “include,” “contain,” and similar terms are defined to mean “comprising” unless specifically stated otherwise.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A mill for dispensing a spice, the mill being adapted to resemble a slot machine, the pepper mill comprising:
a mill body having a compartment for storing the spice, the compartment having an aperture;
a dispensing mechanism operably mounted adjacent the aperture for dispensing the spice through the aperture;
a facade of the mill body adapted to resemble a slot machine; and
a slot arm pivotally mounted adjacent the mill body and operably engaged for actuating the dispensing mechanism.

2. The mill of claim 1, wherein the slot arm operably controls a motor for driving the dispensing mechanism.

3. The mill of claim 2, wherein the mill includes a controller operably connected to a slot arm switch of the slot arm and the motor such that when the slot arm is pulled, the slot arm switch actuates the motor to drive the dispensing mechanism.

4. The mill of claim 3, further comprising reels rotatably mounted adjacent the mill body as part of the façade, and a reel actuator for spinning the reels, the reel actuator being operably connected with the controller.

5. The mill of claim 4, further comprising LEDs mounted on the mill body and forming part of the façade, the LEDs being operably connected with the controller such that the LEDs are illuminated with the slot arm is pulled.

6. The mill of claim 1, wherein the mill further includes a controller operably connected to a slot arm switch of the slot arm, and wherein the controller actuates a reel actuator that functions to rotate reels when the slot arm is pulled.

7. A pepper mill for grinding and dispensing pepper, the pepper mill being adapted to resemble a slot machine, the pepper mill comprising:
a mill body having a compartment for storing the pepper, the compartment having an aperture;
a dispensing mechanism operably mounted adjacent the aperture for dispensing the pepper through the aperture;
a facade of the mill body adapted to resemble a slot machine; and
a slot arm comprising:
a pivot element mounted adjacent the device body; and
a rod extending vertically from the pivot element,
the slot arm being operably engaged for actuating the dispensing mechanism.

8. A pepper mill for dispensing pepper, the pepper mill being adapted to resemble a slot machine, the pepper mill comprising:
a mill body having a compartment for storing the pepper, the compartment having an aperture;
a dispensing mechanism operably mounted adjacent the aperture for grinding and dispensing the pepper through the aperture;
a facade of the mill body adapted to resemble a slot machine;
a slot arm pivotally mounted adjacent the device body, the slot arm having a slot arm switch;
a motor for driving the dispensing mechanism;
reels rotatably mounted adjacent the mill body;
a reel actuator for rotating the reels; and
a controller operably connected with the slot arm switch, the motor, and the reel actuator, such that pulling the slot arm imitates the motor to drive the dispensing mechanism, and the reel actuator to rotate the reels.
